(19) United States
(12) Patent Application Publication
(10) Pub. No.: US 2023/0335345 A1
(43) Pub. Date: Oct. 19, 2023

(54) HIGH POROSITY METAL ORGANIC FRAMEWORK COATED WITH ACTIVATED CARBON NANO-ONION FOR AN ELECTRODE

(71) Applicant: NDB Inc., San Francisco, CA (US)

(72) Inventors: Nima GOLSHARIFI, London (GB); Suguru Frederick AMAKUBO, London (GB)

(73) Assignee: NDB Inc., San Francisco, CA (US)

(21) Appl. No.: 17/928,967

(22) PCT Filed: Jun. 3, 2020
(86) PCT No.: PCT/US2020/035924

§ 371 Date: Dec. 1, 2022

(51) Int. Cl. H01G 11/26; H01G 11/36; H01G 11/34; H01G 11/86

(52) U.S. Cl. CPC H01G 11/26; H01G 11/36; H01G 11/34; H01G 11/86

(57) ABSTRACT

Disclosed herein is an electrode material for a supercapacitor. More specifically, disclosed is a hybrid structure of a high surface area host structure and embedded carbon structure that could be used as the electrode. The embedded carbon can be of activated nature where it contains pores that the electrolyte ions could utilize. The method of activation of the said activated carbon is also disclosed.

### FIELD

The present disclosure relates to the field of supercapacitors or ultracapacitors. More particularly, the present disclosure relates to supercapacitors or ultracapacitors with electrodes made of carbon composites.

### BACKGROUND

Supercapacitors, also known as the ultracapacitors or electrochemical capacitors, are electric charge storage devices with a significantly wide range of applications. Some examples of electric charge storage devices include consumer electronics (such as but not limited to smartphones, laptops), cordless tools, grid power buffer, voltage stabilizers, medical applications (such as defibrillators), aviation, automotive (cars, bus, racing cars as energy recuperation device during braking) as well as the more traditional use as part of an electronic circuit such as in a Complementary Metal Oxide Semiconductor (CMOS) memory back up. Over the last 10 years, these electric charge storage devices have increasingly become a preferred replacement of traditional chemical battery cells in many fields and industries. The main reason for the switch is due to their ability to be quickly recharged, thereby inconveniencing the user less by the recharge time. Electric charge storage devices have an additional advantage of having a greater cycle life which can allow the devices to have an increased device life. It is generally accepted to have a preferred cycle life of >100,000 cycles, a specific energy of 400 Wh/kg, and a specific power of 40 kW/kg over a 10 sec period.

The reason as to why supercapacitors are able to deliver such cycle life and power is due to their construction. Supercapacitors are a hybrid structure that used elements of batteries and a capacitor. In effect, supercapacitors resemble a capacitor's structure, but use an electrolyte's ions as a means of storing charge like one would in a battery. For this reason, supercapacitors are placed in between a battery and a capacitor on the Ragone plot.

### SUMMARY

The limitations and challenges faced by prior attempts in the art are predominantly in the construction of the supercapacitors. The aforementioned electrolyte's ions are key to the performance of supercapacitors. In addition, the right material for the supercapacitors' electrodes has proved to be difficult to find. The standard electrode material used in the art is activated carbon, despite its low electric conductivity of 0.93 S/cm compared to metals electrodes that are typically in the 10,000 S/cm to 100,000 S/cm. Activated carbon is often chosen for its high surface area on the order of 900 m²/g to 2000 m²/g. Activated carbon is also known to have mesopores (typically 2-50 nm) and micropores (typically <2 nm) that can increase the surface area of the electrode. As such, there is a greater surface area for the electrolyte ions to interact with and therefore can increases its charge storage performance.

Recent developments in supercapacitors, however, have faced some challenges in improving the electrode. The design of supercapacitors can dictate that the electrode should be of a certain thickness. For example, the currently preferred thickness is 50 μm. This can present a challenge due to the restriction in thickness. The surface area of the electrode which determines the charge storage capability can be required to be met from the surface structure alone. The current solution is to use activated carbon that has a high surface area porous structure within that thickness confinement. This can allow for some surface area while maintaining some flow of ions. However, the pores also represent wasted volume that is not being utilized by the electrode. If one was to use a denser packed electrode material to fill the said unutilized space on the other hand, such as by using the aforementioned metal electrodes, it can restrict the flow of ions resulting in reduced performance. The following references, which are hereby incorporated by reference in their entirety, provide examples of known supercapacitors.
Zhang, L. L. and Zhao, X. S., 2009. Carbon-based materials as supercapacitor electrodes. Chemical Society Reviews, 38(9), pp 0.2520-2531.
Snook, G. A., Kao, P. and Best, A. S., 2011. Conducting-polymer-based supercapacitor devices and electrodes. Journal of power sources, 196(1), pp. 1-12.
Zhu, Y., Murali, S., Stoller, M. D., Ganesh, K. J., Cai, W., Ferreira, P. J., Pirkle, A., Wallace, R. M., Cychosz, K. A., Thommes, M. and Su, D., 2011. Carbon-based supercapacitors produced by activation of graphene. science, 332(6037), pp. 1537-1541.
Kumar, R., Gupta, P. K., Rai, P. and Sharma, A., 2018. Free-standing Ni 3 (VO 4) 2 nanosheet arrays on aminated r-GO sheets for supercapacitor applications. New Journal of Chemistry, 42(2), pp. 1243-1249.

Applicants have discovered a type of electrode structure that can allow for the greatest amount of electrode material packing per volume that can also allow the flow of ions to be permitted. Specifically, Applicants discovered a high surface area host structure embedded with carbon material for use in an electrode material for supercapacitors and other applications. In some embodiments, the electrode can include an electrochemically active material and activated carbon of porous structure embedded into a high surface area host. The embedded carbon structure can be of several configurations: sp² carbon structures, sp³ carbon structures, or hybrid structures of the two. One or more carbon structures can also be present in the porous structure wherein the said one or more carbon structures could be of one or more type of carbon structure. The porous structure can be mesoporous and/or micropore in nature and have a diameter of up to 50 nm. The mesopores and/or micropores can increase the surface area which can increase access for electrolytes. The mesopores and/or micropores can originate from both the host and carbon structure and in another configuration from either of the two.

In addition, Applicants have discovered a method that activates the carbon structure through the use of chemical and physical activation, where the physical and chemical activation can be carried out alone or in a combination of the two. The chemical activation can be one of a reagent based process where the chemical reagents activate the carbon structures developing pores. The physical activation can be one of plasma, reactive gas and photoactivation based process where the plasma, reactive gas, and photon-induced reaction activates the carbon structure. Both chemical and physical activation can alternatively be used as a means of functionalising the carbon structures where the altered carbon can develop new properties such as increased solubility in solvents.

In some embodiments, an electrode includes a high surface area host structure comprising a plurality of pores; and a carbon structure embedded within the plurality of pores of the high surface area host structure. In some embodiments, the high surface area host structure includes a Metal Organic Frameworks (MOF), Isoreticular Metal Organic Frameworks (IRMOF), activated carbon, shungite, zeolite, aerogels (e.g., carbon aerogels, silica aerogels, metal oxide aerogels, hybrid aerogels); carbide-derived materials (CDM); and polymers as well as but not limited to other porous materials that can act as a host such as but not limited to MCM-41, MCM-48, MCM-50, SBA-15 and SBA-16. In some embodiments, the MOF comprises Ni₃(2,3,6,7,10,11-hexaiminotriphenylene)₂, Zn₄O(BDC)₃ (MOF-5), Zn₄O(BTB)₂ (MOF-177), Zn₄O(BBC)₂ (MOF-200), Zn₄O(BTE)(BPDC) (MOF-210), Mn₃[(Mn₄Cl)₃(BTT)₈]₂ (Mn-BTT), Cu₃(BTC)₂(H₂O)₃ (HKUST-1), Co₂(ad)₂(Co₂CH₃)₂(MOF-11), Zn₂(H4dhtp) (MOF-74-Zn), Cu₂O(BDC-Br)₂(H₂O)₂(MOF-101), Cu₂O(bptc)(H₂O)₃(DMF)₃ (MOF-505), Zr₆O₄(OH)₄(TCPP-Fe)₃ (MOF-525), [Fe₃O(BDC)₃(DMF)₃][FeCl₄] (DMF)₃ (MOF-235), Al(OH)(BPYDC) (MOF-253). In some embodiments, the MOF is Ni₃(2,3,6,7,10,11-hexaiminotriphenylene)₂. In some embodiments, the plurality of pores comprise at least one of mesopores and micropores. In some embodiments, the mesopores have a diameter of 2-50 nm and the micropores have a diameter of less than 2 nm. In some embodiments, the plurality of pores comprise mesopores and micropores. In some embodiments, the mesopores comprise the micropores. In some embodiments, the micropores are inside the mesopores. In some embodiments, the micropores are present on non-mesopore surfaces of the high surface area host structure. In some embodiments, the carbon structure comprises at least one of carbon nano-onion (CNO), carbon nanotube (CNT), graphene flake/platelet/ribbon, amorphous carbon, diamond-like carbon, Buckminsterfullerene, carbon fibre derived materials, sp² carbon pill, or sp³ carbon. In some embodiments, the carbon structure comprises CNO. In some embodiments, the carbon structure is an activated carbon structure. In some embodiments, the carbon structure comprises a plurality of perforations. In some embodiments, the carbon structure comprises activated CNO (ACNO). In some embodiments, the ACNO has a BET specific surface area of about 50-2000 m²/g. In some embodiments, the ACNO has a mesopore diameter of up to 50 nm. In some embodiments, the ACNO has a micropore diameter of up to 2 nm. In some embodiments, the ACNO has a crystallize size of about 0.1-10 nm. In some embodiments, the ACNO has a stability temperature of up to 710° C. in air and/or up to 2500° C. in vacuum.

In some embodiments, a method of making an electrode includes preparing a first solution comprising a high surface area host structure and a first solvent; preparing a second solution comprising a carbon structure and a second solvent; mixing the first solution with the second solution to form an electrode solution; sonicating the electrode solution; heating the electrode solution; and drying the electrode solution to form the electrode. In some embodiments, the first and second solvents comprise at least one of dimethylformamide, acetone, phenol, catechol, and pyrogallol. In some embodiments, the method includes cooling the electrode solution, filtering the electrode solution, and washing the electrode solution prior to drying the electrode solution.

In some embodiments, a method of activating sp² carbon structures includes preparing a solution comprising an sp² carbon structure and an activation reagent; sonicating the solution; vacuum filtering the solution to remove the sp² carbon structure from solution; heating the sp² carbon structure to a temperature of 50-100° C.; annealing the sp² carbon structure at temperature greater than 700° C. under a nitrogen flow; and cooling the sp² carbon structure under a nitrogen flow. In some embodiments, the activation reagent comprises KOH, K₂CO₃, Na₂CO₃, NaOH, ZnCl₂, H₃PO₄. In some embodiments, the activation reagent has a concentration of about 7M or less in the solution.

In some embodiments, a method of activating sp² carbon structure includes exposing an sp² carbon structure to nitrogen plasma, NH₃ ultraviolet amination, or ozone. In some embodiments, exposing the sp² carbon structure to nitrogen plasma, NH₃ ultraviolet amination, or ozone creates perforations in the sp² carbon structure. In some embodiments, exposing the sp² carbon structure to nitrogen plasma, NH₃ ultraviolet amination, or ozone functionalizes the sp² carbon structure.

Additional advantages will be readily apparent to those skilled in the art from the following detailed description. The examples and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE DRAWINGS

Exemplary embodiments of the present disclosure can be illustrated by way of example in the accompanying drawings in which like reference numbers indicate the same or similar elements unless stated differently herein. Further details, advantages and features of the embodiments are found not only in the claims but there-in alone and/or in combination with the drawings. The drawings are as follows:

FIG. 1 is an illustrative diagrammatic representation of an activated carbon structure embedded into a high surface area host in accordance with some embodiments disclosed herein.

FIG. 2 is an illustrative diagrammatic representation of electrolyte ions attached to the surface of the host in accordance with some embodiments disclosed herein.

FIG. 3 is an illustrative diagrammatic representation of an activated carbon structure embedded into a high surface area host where ions are present within the activated carbon structure as well as on the surface in accordance with some embodiments disclosed herein.

FIG. 4 is an illustrative diagrammatic representation of mesopores acting as an access channel to micropores in accordance with some embodiments disclosed herein.

FIG. 5 is an illustrative diagrammatic representation of mesopores acting as an access channel to micropores, wherein the micropores and the surface of the host have been filled by the carbon structure in accordance with some embodiments disclosed herein.

FIGS. 6A-F are high-resolution transmission electron micrographs showing chemical activation of CNO: (a) Pristine NDCNO @1780; (b) ACNO KOH-3M annealed; (c) ACNO KOH-7M annealed; (d) ACNO KOH-10M annealed; (e) ACNO H₃PO₄ annealed; and (f) ACNO NaOH annealed.

FIG. 7 is a graph representing the pore volume of CNOs and Braunauer-Emmett-Teller Specific Surface Area as a function of the KOH concentration.

FIG. 8 is a graph representing the N₂ adsorption and desorption isotherms corresponding to the CNOs and ACNOs.

FIG. 9 is a table representing the mean pore dimensions of the CNOs.

FIGS. 10A-D is a group of graphs representing: (a) NLDFT pore size distribution for the CNO @1780 and ACNOs (K₂CO₃ Annealed, KOH-3M Ozone, KOH-5M N₂ Plasma, KOH-5M NH₃ UVA, KOH-7M N₂ Plasma); (b) QSDFT pore size distribution for the CNO @1780 and ACNOs (K₂CO₃ Annealed, KOH-3M Ozone, KOH-5M N₂ Plasma, KOH-5M NH₃ UVA, KOH-7M N₂ Plasma); (c) Pore volume vs pore width based on NLDFT; and (d) Pore volume vs pore width based on QSDFT.

FIGS. 11A-D is a group of graphs representing the effect of chemical annealing, chemical annealing followed by N₂ Plasma functionalization, and chemical annealing followed by NH₃ UV Amination over: (a) cumulative mesopores diameter; (b) cumulative mesopores volume; (c) cumulative micropore diameter; and (d) cumulative micropore volume.

FIG. 12 is a graph representing the effect of chemical annealing with different KOH concentration over cumulative mesopores and micropores diameters and volumes.

FIG. 13 is a table of average diameter and d-space between CNO samples based on 30 randomly selected CNOs from HRTEM images per samples and FWHM, d-space, and crystallite size based on XRD patterns.

### DETAILED DESCRIPTION

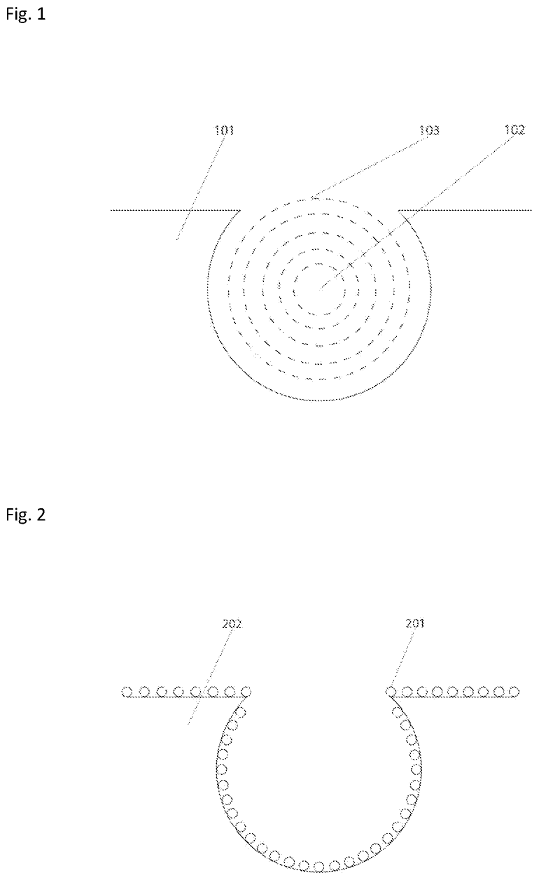

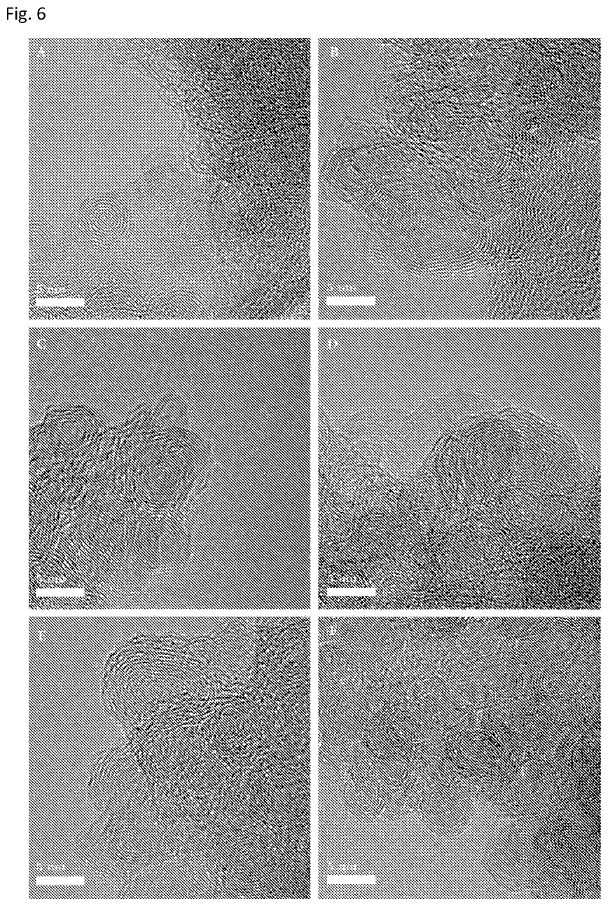

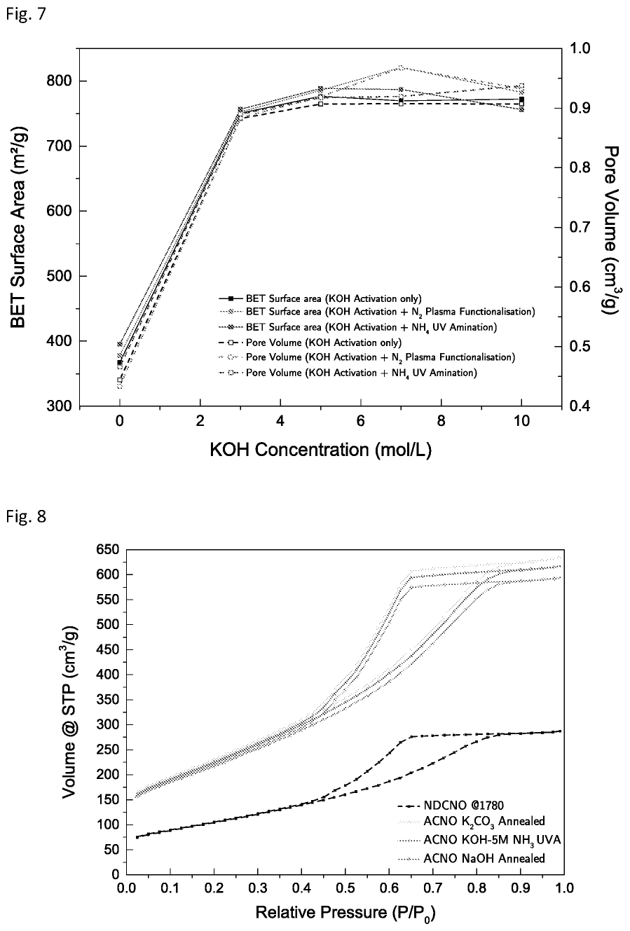

Applicants have discovered a high surface area host structure embedded with carbon material for use in an electrode material for supercapacitors and other applications. The following describes an electrode with a high surface area host and a carbon structure, and a method of activation of the said carbon structure that can create perforations. Specifically, as shown in FIG. 1, the large surface area host 101 can contain the carbon structure 102. In some embodiments, the carbon structure can be added to the large surface area host 101. In some embodiments, the large surface area host can be synthesized around the carbon structures. In addition, the said carbon structure can be ‘activated’ (i.e., a term used by those in the art of perforating carbon) to create perforations 103. The dotted circles of perforations 103 in FIG. 1 represent concentric shells of a specific carbon structure, carbon nano-onion (CNO) which are also shown in FIG. 6. Perforation 103 is actually pointing at the gap between each of the dashes of the dotted lines thereby representing the perforation. These perforations can act as access channels of electrolyte ions. The line to 102 is thereby representing the whole carbon structure (i.e., all of the concentric dotted lines).

The composite structures disclosed herein can include two components: the high surface area host 101; and the carbon structure 102. These composite structures can be electrodes. The total surface area of the hybrid structure (hereafter the composite structure) that contains the host and the carbon structure can be increased. The benefit of increasing the surface area of the composite structure relates to its primary use as an electrode material of supercapacitors, also known as electrochemical capacitors. Supercapacitors have several subclasses that include, but are not limited to, Electric Double Layer Capacitors (EDLEs), electrochemical pseudocapacitors, and hybrid capacitors as well as their symmetric and asymmetric variants. The electrode used in supercapacitors is generally preferred to have a high surface area as this can provide a greater surface area for electrolyte ions 201 to attach itself to the electrode 202, as shown in FIG. 2. This, in turn, can manifest as greater energy storage capability. As such, by increasing the surface area of the electrode material, the energy, and in turn the electric charge storage performance of the device, can increase. Starting with a high surface area host structure and further increasing this surface area by adding carbon structures into the already high surface area host can improve the performance.

Similar to the high surface area host, the carbon structure can increase the surface area of the overall composite when it is added to the high surface area host. The surface area of the carbon structure can contribute to the overall surface area while being able to allow the flow of ions to reach the deeper layers of the composite structure.

Previous attempts that have tried to do so had one key limitation, space. By the very nature of supercapacitor's design, the surface area can be required to be packed into a very small volume (typically at a thickness of about 53.1 μm following optimization to minimize internal resistance). This can create a dilemma that if an electrode material was so densely packed it may constrict the flow of the ions and lose performance. On the other hand, if one was to make the electrode material more porous, then it can have less electrode material for the ions to attach itself to. The current workaround in the art is to use porous material (typically activated carbon) that can strike the right balance between having a densely packed surface area while maintaining ion flow.

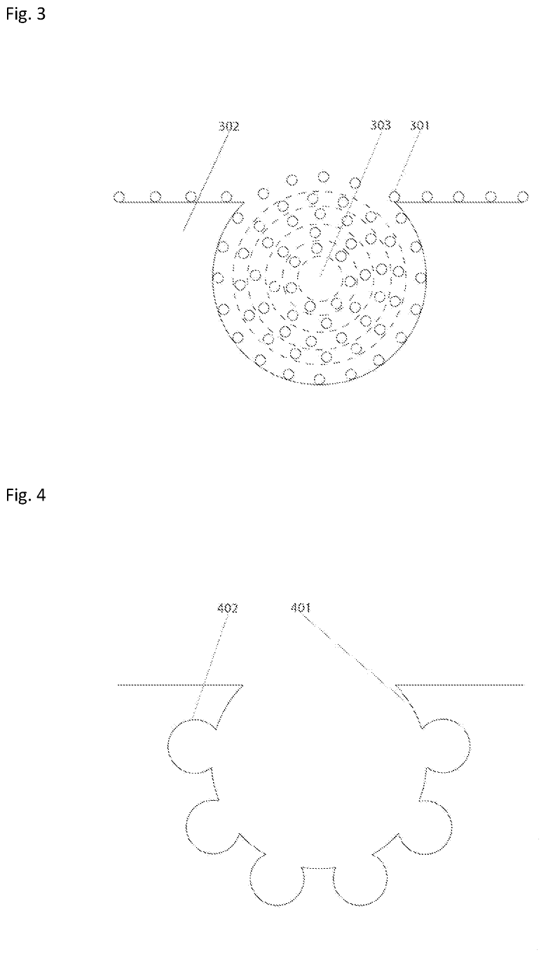

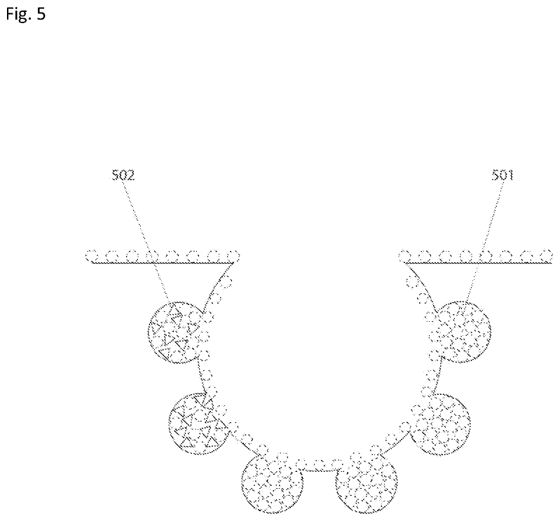

The composite structures disclosed herein addresses this dilemma by having a high surface area host 302 which then has a porous carbon structure 303 that fills its pores/cavities, as shown in FIG. 3. Since the porous carbon structure can acts as an electrode material in itself while being porous enough for ions 301 to flow through to the deeper layers of the host, the porous carbon structure can effectively increase the surface area of the electrode without sacrificing the ion flow. The composite structure can allow greater surface area for the ions 301 to interact with from the same volume confinement. The composite structure can alternatively be used for other applications where the high surface area could be of benefit. Some examples of these include, but are not limited to, CO₂ capture, H₂ storage for hydrogen vehicles and others, gas purification and separation, catalysis, water purification, and odour removal.

The high surface area host 302 can be made from materials that can be used as electrode materials for supercapacitors that are also capable of hosting carbon structures 303 within their pores and on other surfaces. In some embodiments, the high surface area host can host carbon structures of about 1-500 nm in diameter. This includes, but is not limited to, Metal Organic Frameworks (MOFs), such as but not limited to, Ni₃(2,3,6,7,10,11-hexaiminotriphenylene)₂ (also known as Ni₃(HITP)₂), Zn₄O(BDC)₃ (MOF-5), Zn₄O(BTB)₂ (MOF-177), Zn₄O(BBC)₂ (MOF-200), Zn₄O(BTE)(BPDC) (MOF-210), Mn₃[(Mn₄Cl)₃(BTT)₈]₂ (Mn-BTT), Cu₃(BTC)₂(H₂O)₃ (HKUST-1), Co₂(ad)₂(Co₂CH₃)₂(MOF-11), Zn₂(H₄dhtp) (MOF-74-Zn), Cu₂O(BDC-Br)₂(H₂O)₂(MOF-101), Cu₂O(bptc)(H₂O)₃(DMF)₃ (MOF-505), Zr₆O₄(OH)₄(TCPP-Fe)₃ (MOF-525), [Fe₃O(BDC)₃(DMF)₃][FeCl₄] (DMF)₃ (MOF-235), Al(OH)(BPYDC) (MOF-253); Isoreticular Metal Organic Frameworks (IRMOF) such as, but not limited to, Zn₄O(2-Br-1, 4-H2bdc)₃ (IRMOF-2), Zn₄O(NH₂-H₂BDC)₃ (IRMOF-3), Zn₄O(dcbBn)₃ (IRMOF-6), Zn₄O(H(2)BPDC)₃ (IRMOF-9), Zn₄O(2,7-PDC)₃ (IRMOF-13), Zn₄O(TPDCD)₃ 17DEF 2H₂O (IRMOF-16), Zn₄O(H₂T₂DC)₃ (IRMOF-2), Mg₂(dobpdc)(Mg-IRMOF-74), Cu₂(PZDC)₂(4,4′-BPY) (CPL-2); activated carbon; shungite; zeolite; aerogels (e.g., carbon aerogels, silica aerogels, metal oxide aerogels, hybrid aerogels); carbide-derived materials (CDM); and polymers as well as but not limited to other porous materials that can act as a host such as but not limited to MCM-41, MCM-48, MCM-50, SBA-15 and SBA-16. CDM has a unique property of being able to tune the pore size according to its preparation method. As such, different pore sizes can be utilized for CDMs.

In some embodiments, the high surface area host can be composed of one or more types of hosts to form a single host entity. In some embodiments, the high surface area host can be of a natural, artificial, or derivative product from similar materials. In some embodiments, the high surface area host 302 can include both mesopores 401 and micropores 402. In some embodiments, the typical pore diameter is about 2-50 nm for mesopores and <2 nm micropores. In some embodiments, the high surface area host has only mesopores 401 or micropores 402 alone.

In some embodiments, the mesopores and/or micropores can not only be from that of the host structure, but also internally from the carbon structure itself. As such, in some embodiments, the carbon structure also contains mesopores and/or micropores. In the composite structures, it can be preferred to have both micropores as well as mesopores in order to benefit from the pseudocapacitance generated by the micropores as well as the Helmholtz double-layer which together contributes to the overall charge storing capability of the composite structure.

In some embodiments, the embedded carbon structure 303 can be a carbon-based material that can be embedded into the host 302. The carbon structure can be embedded into the high surface area host within its pore structure, superficially on its surface, and/or integrated structurally into the host. The said carbon structure 303 embedded into the host 302 can be of singular or plurality and the said pore structure could be micropores or mesopores or a combination of both. In some embodiments, the carbon structure 303 includes, but is not limited to, carbon nano-onion (CNO), carbon nanotube (CNT), graphene flake/platelet/ribbon, Buckminsterfullerene, carbon fibre derived materials, and/or other sp² carbon hybrid structures such as, but not limited to, orthogonal CNTs and sp² carbon pill and their functionalised, single layered, and multi layered variants of the said carbon structure materials which is of natural, artificial, or derivative origin.

In some embodiments, one of the said carbon structures 303 can be used, but other embodiments include more than one type of carbon structures 303. In some embodiments, the use of non-pure sp² carbon materials, such as but not limited to, amorphous carbon and diamond-like carbon (DLC) or pure sp³ carbon materials such as, but not limited to, nanodiamond, diamondoid, single crystal diamond, polycrystalline diamond, diamond like carbon, sintered diamond, amorphous diamond, diamond powder, and doped variants of the said carbon based starting materials which is of natural, artificial, or derivative origin can be employed. In some embodiments, the carbon structures can be in the class of nanomaterials, both in size and characteristics. In some embodiments, the carbon of the carbon structure can be of artificial, natural, or derived from similar materials such as, but not limited to, CNT fragments in origin. In some embodiments, the carbon structure is CNO. CNO is a concentric shell of sp² carbon resembling the material graphene in an onion-like configuration.

The CNO can be ‘activated’, a term used in the art to describe the state where the sp² based carbon materials are perforated to make it porous. In some embodiments, the carbon structure is activated CNO (ACNO). The porous nature of the ACNO can allow the ions 301 to flow through the CNO to the deeper layers of the high surface area host 302. CNOs can include many desirable properties for supercapacitor electrodes. The desirable properties can include, but are not limited to, good conductivity, high-temperature stability, long-term chemical stability, high corrosion resistance, and high surface area per volume and mass.

Firstly, CNO is a derivative structure of graphene where it is known to have one of the highest electrical conductivity of all known materials. In practice, due to the topological perturbation of the structure, the conductivity is lowered to a typical value of 2-4 S/cm. However, this value can still be significantly higher than the conductivity of activated carbon 0.93 S/cm which is the most commonly used material in the art. The use of a higher conductivity material can present an improvement over the current state of the art devices. In some embodiments, the CNOs can include CNOs of diameters up to about 500 nm. In some embodiments, the CNOs can have a diameter of about 5-200 nm. In some embodiments, the diameter of the CNOs can be less than or equal to 5 nm.

Secondly, CNOs can be made from sp² carbon bonds which has a typical bond strength (bond dissociation enthalpy) of 15.87 kJ/mol when in the form of CNOs. This value is comparable to 14.98 kJ/mol of activated carbon that is commonly used in the art. The bond strength of the CNOs can contribute to the high thermal stability, long term chemical stability, and high corrosion resistance of the embodiment where the bond strength is capable of withstanding thermal and chemical damage. One example of this can be seen from the reagents and temperatures that are required to break the sp² bonds of CNOs. Typically, it is agreed by those in the art that for one to break the sp² bonds in a carbon onion one would need strong chemical reagents such as concentrated nitric acid at a high temperature of 120° C. for 4 hr for it to be partially damaged. If in the air, the same CNOs can be capable of withstanding a temperature of 710° C. These values are all significantly beyond the remits of typically expected working conditions of the composite structure's intended uses such as an electrode material for a supercapacitor. The composite structures disclosed herein can exploit this stability and robustness of the CNO by having it maintain its structural integrity post-activation. Activation can be a process of which it perforated the walls of the CNO such that it: a) can allows ions 301 to have access to deeper layers of the pores; and/or b) can act as electrode material in itself. In both cases, the CNO can maintain structural integrity so as not to collapse and block the flow of ions 301. This is an improvement over recent attempts in the art where reduced-Graphene Oxide (r-GO) flakes were used to increase surface area. It is known in the art that graphene after a certain size is known to ‘curl-up’ into a loose tube-like structure or ‘fold’ akin to a sheet of paper and therefore collapses structurally reducing its effectivity. It is generally agreed by those in the art that this phenomenon occurs to flakes with widths that are about 50 nm. CNO is a spherical structure with three-dimensional support that can maintain its structural integrity, securing an ion flow channel, and therefore are able to mitigate this problem that was faced by previous attempts in the art.

Thirdly, CNO is a concentric shell structure and as such, it can scale according to the need of the pore. As such, by fine-tuning the fabrication process of the CNO itself, one can tailor the size of the CNO to the pore size of the host. In some embodiments, multiple CNOs 501 are present in the pores. The CNO can be a ball-like structure capable of having a high packing density whilst maintaining structural integrity as seen from FIG. 6. In some embodiments, the composite structure can include non-CNO carbon structures 502 in conjunction with the CNO that contains the aforementioned alternative materials to carbon structure 303 as well as, but not limited to, polymers, metals, and ceramics. In some embodiments, the CNO 501 and carbon structure 502 could not only fill the micropores but the mesopores as well in a similar manner to how CNO 501 and carbon structure 502 are filling the micropores in FIG. 5.

There are various methods of incorporating carbon structures into the high surface area host including, but not limited to: (1) hydrothermal synthesis; (2) internal synthesis; (3) microwave assisted synthesis; (4) electrochemical synthesis; (5) mechanochemical synthesis; (6) precipitation reaction; (7) sonochemical synthesis; (8) 3D printing; (9) pyrolysis; (10) supercritical drying; (11) sol-gel chemistry, post or in some embodiments can be without mixing of carbon structure to host starting material using mixing methods such as, but not limited to, high-shear mixing, ultrasonication, heat shearing, ball milling, stirring, and extrusion.

The hydrothermal synthesis is one where a pre-synthesised carbon structure 303 is added to the high surface area host 302. This method has the advantage of being able to process the carbon structures 303 prior to its addition to the host 302, where such processes include, but are not limited to, activation and functionalisation. This merits from having activated CNOs embedded into the host 302. Another incorporation method is internal synthesis where a carbon precursor can be added to the host and converted into nanoporous carbon within the high surface area host. In some embodiments, the carbon precursor includes, but is not limited to, furfuryl alcohol.

The recipe of the hydrothermal synthesis can vary according to the carbon structure to be incorporated and the type of the high surface area host. For sp² material-based carbon structures such as in the case of CNOs, it is generally accepted use dimethylformamide (DMF) as its solvent. However, alternative solvents such as acetone, phenol, catechol, pyrogallol can also be used. The solvent can be of one type of solvent or a mixture. In some embodiments, the method can include preparing a first solution that includes a high surface area host structure and/or reagents that the host structure is synthesized from and a first solvent and preparing a second solution that includes a carbon structure and a second solvent. For example, two separate solutions, one with the 10 ml solvent and 0.5 mg of the host material and/or reagents that the host structure is synthesised from and another with 20 ml solvent and 5 wt % of the carbon structure can be used. Both solutions can be sonicated at 40 kHz separately for 30 min (the length of time will vary according to the nature of the carbon structure being sonicated). Once sonicated individually, the solutions can be mixed together to form an electrode solution and further sonicated for 30 min at 40 kHz. Post sonication, the solution can be heated to 120° C. for 24 h. The solution can then be cooled to room temperature naturally, filtered, and the residue washed with ethanol and vacuum dried at room temperature.

As previously stated, the carbon structure can be activated. The carbon structures that can be activated can include sp² based carbon structures 303 such as, but are not limited to, CNO, CNT, graphene flake/platelet/ribbon, Buckminsterfullerene, carbon fibre derived materials and other sp² carbon hybrid structures such as, but not limited to, orthogonal CNTs and sp² carbon pill and their functionalized, single layered, and multi layered variants of the said carbon structure materials which is of natural, artificial, or derivative origin. The activation method can be one that is able to activate and thus break the sp² bonds and make the carbon structure 303 porous. The locations of the perforations can be determined by the location of the surface defects such as the Stone-Wales defect. It is established in the art that defects such as, but not limited to, the aforementioned Stone-Wales defects can be the location where sp² bonds are more likely to break since the sp² bonds found on defect sites are under energy strain. As such, the perforation location can have a high correlation with the defect location. Since the mathematical law of large numbers dictates that it is statistically very unlikely for the defect sites to be clustered in a single location of the carbon structure 303's shell, the perforation locations can be said to be distributed relatively evenly across the carbon structure 303's shell. This is confirmed by FIG. 6 where the CNOs have been activated excessively to the point of breakdown in structure but has maintained the overall shell structure due to the even distribution of perforations.

As described earlier, sp² carbon materials have a high tolerance to chemical and physical damage and it is known in the art that the activation process especially one where it maintains the structural integrity of the carbon structure 303 to be challenging. The activation methods can be categorized into two sections: (1) chemical; and (2) physical. Chemical activation method can activate the carbon structure 303 through the use of reagents and physical activation method can achieve activation through the use of reactive gas and photoexcitation. In some embodiments, the chemical and physical activation could be used together with one after the other. In some embodiments, the physical and chemical activation could be carried out one without the other.

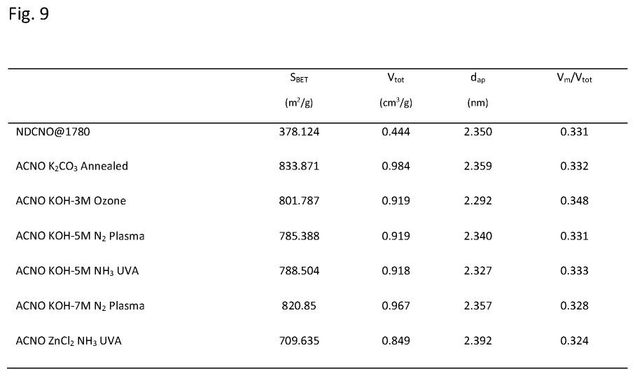

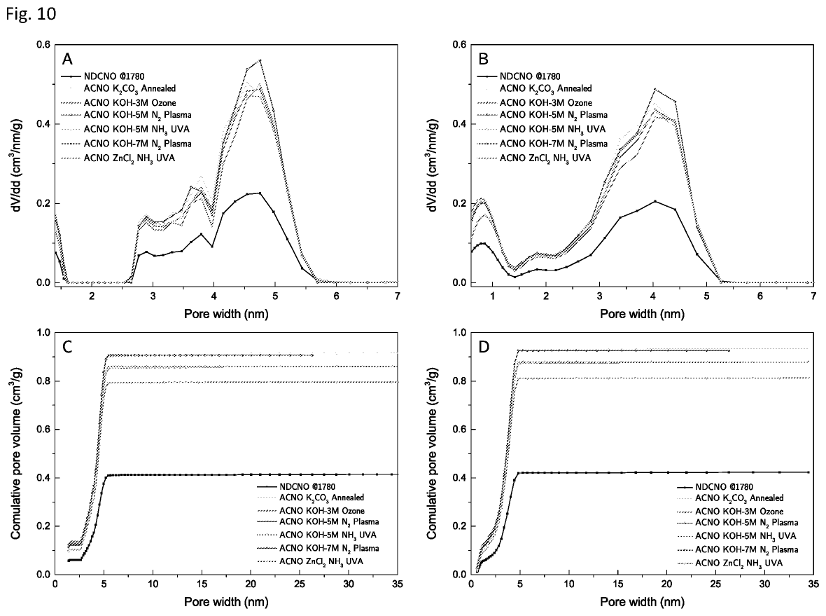

In some embodiments, the chemical activation method can include preparing a solution of carbon structure and an activation reagent. For example, the chemical activation method can be carried out by adding about 300 mg of carbon structure 303 into about 10 ml of activation reagent that includes, but is not limited to, KOH of about 3, 5, 7 and 10 mol/l as well as K₂CO₃, Na₂CO₃, NaOH, ZnCl₂, H₃PO₄ of but not limited to (85 wt % H₂O). This can be followed by 1 hr of sonication. The sample can then be placed in ambient conditions for 24 hrs and filtered to remove the carbon material from solution. In some embodiments, a vacuum filtration system is used. However, other modes of filtration can also be used. The sample can then be transferred and heated to about 50-100° C. (e.g., 80° C.) for about 24 hr in a sample oven. Post heating, the sample can further be heated to greater than about 700° C. (e.g., 800° C.) for about 1 hr under about 100 SCCM flow rate of nitrogen at a temperature ramp rate of about 10° C. and cooled under the said nitrogen flow. All values stated can include other values of a similar degree. It was found that the chemical activation method used can create porosity, more open mesopores of wide distribution, and high surface areas within the ACNOs. Moreover, the annealing process at about 800° C. during the chemical activation process can increase the surface area as seen from FIG. 9. The annealing in the chemical activation can also significantly increase the diameter and volume of the mesopores. In some embodiments, the use of KOH of concentration up to about 7M can be preferred. As shown in FIG. 6, CNOs that has been exposed to KOH of higher than 7 can lose their structural integrity.

Physical activation method can be carried out by exposing the samples to reactive gases and/or light. This includes, but is not limited to, nitrogen plasma, NH₃ ultraviolet amination, and ozone. For the nitrogen plasma process, the samples can be exposed to direct current plasma enhanced chemical vapour deposition system's nitrogen plasma. For example, 10 mg of carbon structures can be added to a molybdenum crucible. The chamber can then be pumped down to about 10⁻³ mBar. The sample can be pre-heated to about 200° C. in nitrogen gas flow of about 30 sccm under the pressure of about 5333 Pa for about 30 min. The direct current nitrogen plasma can be ignited and the samples exposed for about 30 min. The plasma can be extinguished and left to cool to ambient temperature with nitrogen gas flow. For the NH₃ ultraviolet amination, about 10 mg of carbon structures can be added to a molybdenum crucible. The sample can be exposed to NH₃ gas flow of about 30 sccm under the pressure of about 1333 Pa for about 30 min. The sample can be exposed to UV ray for about 30 min followed by the NH₃ gas flow termination. For the ozone process, about 10 mg of carbon structures can be added to a molybdenum crucible. The chamber can be pumped down to about 10⁻³ mBar and heated at about 100° C. for about 20 min. Ozone can then be introduced to the chamber for about 30 min. The heating can then be turned off to allow the sample to cool in ozone for about 30 min. Once the sample temperature has reached room temperature, ozone can be turned off. ACNOs that are physically activated in the above manner, namely nitrogen plasma and NH₃ ultraviolet amination, was found to demonstrate hydrophilic properties and therefore increased solubility in aqueous solutions. The use of this process can bring about two benefits of having improved compatibility to electrolytes and increase the choice of solvents when incorporating the carbon structures 303 to the host 302.

In addition, exposing the carbon structure to these various activation components can be not only for the activation, but it can also functionalize the carbon structure, relative to the activation method. For example, ozone exposure can add ozone functionalization to the carbon structure, nitrogen plasma exposure can add nitrogen functionalization, and NH₃ ultraviolet can add amine functionalization.

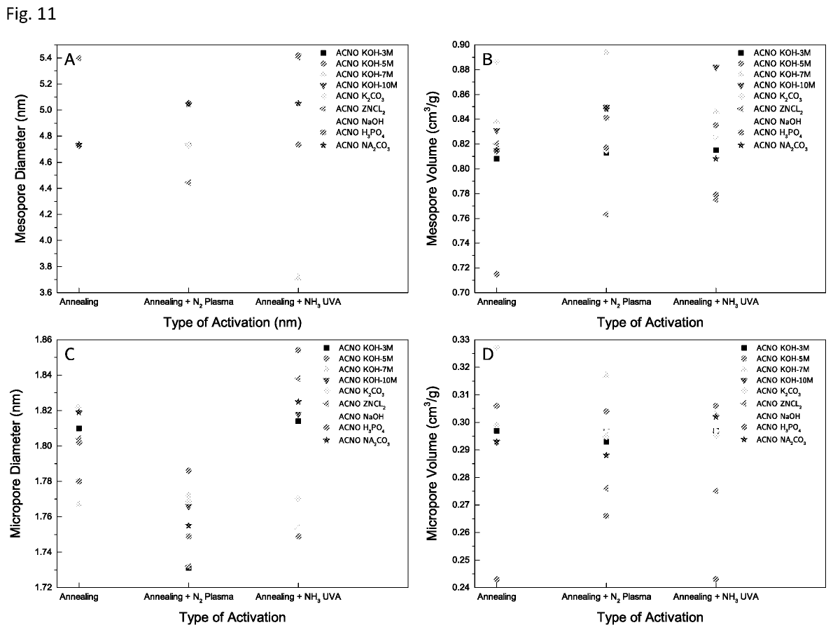

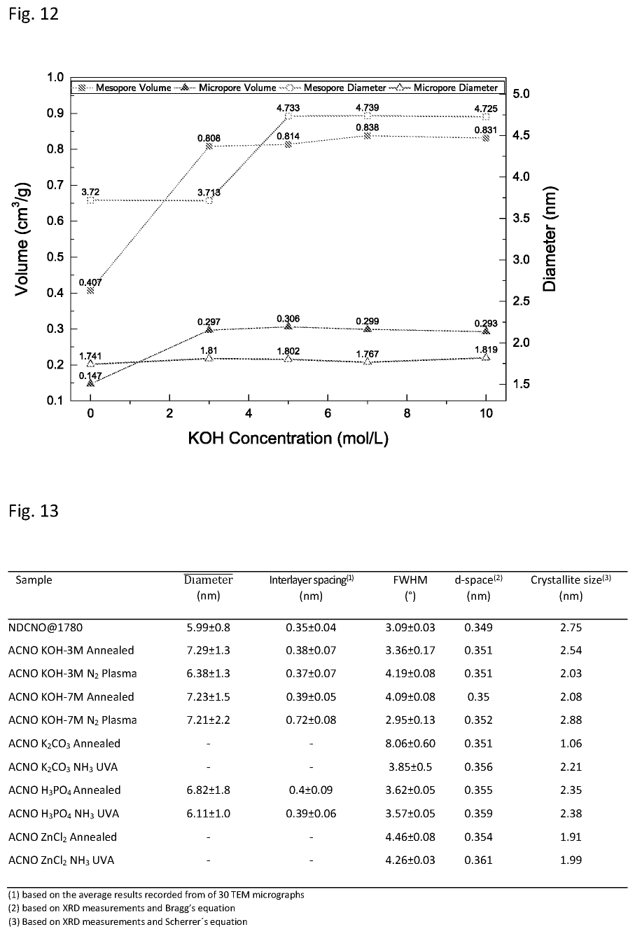

Overall, the combination of chemical and physical activation can bring about an enhanced performance by the ACNOs. Specifically, it can result in an increase of the surface area of the ACNOs and can introduce higher levels of homogenous micropores in size. Of the aforementioned ACNOs and their chemical and physical activations, the ACNO that was chemically activated using K₂CO₃ had the highest Brunauer, Emmett and Teller (BET) specific surface area (SSA) of 833.871 m²/g as seen from the table FIG. 9 which contained a narrow mesopore diameter of 4.725 nm and a large micropore diameter of 1.819 nm both as seen from FIGS. 11 and 12. It also had the smallest crystallite size of 1.06 nm as shown in FIG. 13 and a stability temperature of 710° C. in air.

In some embodiments, the BET specific surface area for the ACNO can be about 50-2000 m²/g, about 100-1000 m²/g, about 300-1000 m²/g, about 350-850 m²/g, or about 370-840 m²/g. BET is a well-established characterization method that is known in the art using N₂ at 77K, its boiling point to obtain the adsorption data.

In some embodiments, the range of narrow mesopore diameter for the ACNO can be up to about 50 nm, up to about 20 nm, up to about 10 nm, or up to about 5 nm. In some embodiments, the range of narrow mesopore diameter for the ACNO can be about 0.1-50 nm, about 0.1-20 nm, about 0.1-10 nm, about 0.5-5 nm, about 1-5 nm, or about 3-4 nm. The mesopore diameter can be measured using Non-Local Density Functional Theory (NLDFT) and/or Quenched Solid Density Functional Theory (QSDFT) characterization procedures used and known in the art especially for carbon porosity. Both the NLDFT and QSDFT were in agreement with each other. In some embodiments, the range of large micropore diameter for the ACNO can be up to about 2 nm. In some embodiments, the range of large micropore diameter for the ACNO can be about 0.1-2 nm, about 0.5-2 nm, about 1-2 nm, or about 1.5-2 nm. The micropore diameter can be measured using Non-Local Density Functional Theory (NLDFT) and/or Quenched Solid Density Functional Theory (QSDFT) characterization procedures used and known in the art especially for carbon porosity. Both the NLDFT and QSDFT were in agreement with each other.

In some embodiments, the crystallite size for the ACNO can be about 0.1-10 nm, about 0.5-5 nm, about 1-5 nm, or about 1-3 nm. The crystallite size can be measured using Powder X-Ray Diffraction (XRD), a characterization procedure used and known in the art.

In some embodiments, the stability temperature of the ACNO can be up to about 710° C. in air and/or up to about 2500° C. in vacuum.

These displayed optimal properties required by the composite structure's application as an electrode of supercapacitors. Furthermore, it can contain pores that have easy electrolyte ion access that also displays pseudocapacitance with a short ion diffusion pathway for reduced charge transfer resistance.

### Additional Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters. For example, a statement that an electrode has a thickness of at least about 5 cm, about 10 cm, or about 15 cm is meant to mean that the electrode has a thickness of at least about 5 cm, at least about 10 cm, or at least about 15 cm.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

1. An electrode comprising:
high surface area host structure comprising a plurality of pores;
a carbon structure embedded within the plurality of pores of the high surface area host structure.

2. The electrode of claim 1, wherein the high surface area host structure comprises a Metal Organic Frameworks (MOF), Isoreticular Metal Organic Frameworks (IRMOF), activated carbon, shungite, zeolite, aerogels, carbide-derived materials (CDM), and polymers.

3. The electrode of claim 2, wherein the MOF comprises Ni₃(2,3,6,7,10,11-hexaiminotriphenylene)₂, Zn₄O(BDC)₃ (MOF-5), Zn₄O(BTB)₂ (MOF-177), Zn₄O(BBC)₂ (MOF-200), Zn₄O(BTE)(BPDC) (MOF-210), Mn₃[(Mn₄Cl)₃(BTT)₈]₂ (Mn-BTT), Cu₃(BTC)₂(H₂O)₃ (HKUST-1), Co₂(ad)₂(Co₂CH₃)₂(MOF-11), Zn₂(H₄dhtp) (MOF-74-Zn), Cu₂O(BDC-Br)₂(H₂O)₂ (MOF-101), Cu₂O(bptc)(H₂O)₃(DMF)₃ (MOF-505), Zr₆O₄(OH)₄(TCPP-Fe)₃ (MOF-525), [Fe₃O(BDC)₃(DMF)₃][FeCl₄] (DMF)₃ (MOF-235), Al(OH)(BPYDC) (MOF-253).

4. The electrode of claim 3, wherein the MOF is Ni₃(2,3,6,7,10,11-hexaiminotriphenylene)₂.

5. The electrode of claim 1, wherein the plurality of pores comprise at least one of mesopores and micropores

6. The electrode of claim 5, wherein the mesopores have a diameter of 2-50 nm and the micropores have a diameter of less than 2 nm.

7. The electrode of claim 5, wherein the plurality of pores comprise mesopores and micropores.

8. The electrode of claim 7, wherein the mesopores comprise the micropores.

9. The electrode of claim 8, wherein the micropores are inside the mesopores.

10. The electrode of claim 8, wherein the micropores are present on non-mesopore surfaces of the high surface area host structure.

11. The electrode of claim 1, wherein the carbon structure comprises at least one of carbon nano-onion (CNO), carbon nanotube (CNT), graphene flake/platelet/ribbon, amorphous carbon, diamond-like carbon, Buckminsterfullerene, carbon fibre derived materials, sp² carbon pill, or sp³ carbon.

12. The electrode of claim 11, wherein the carbon structure comprises CNO.

13. The electrode of claim 1, wherein the carbon structure is an activated carbon structure.

14. The electrode of claim 1, wherein the carbon structure comprises a plurality of pores.

15. The electrode of claim 1, wherein the carbon structure comprises activated CNO (ACNO).

16. The electrode of claim 15, wherein the ACNO has a BET specific surface area of about 50-2000 m²/g.

17. The electrode of claim 15, wherein the ACNO has a mesopore diameter of up to 50 nm.

18. The electrode of claim 15, wherein the ACNO has a micropore diameter of up to 2 nm.

19. The electrode of claim 15, wherein the ACNO has a crystallize size of about 0.1-10 nm.

20. The electrode of claim 15, wherein the ACNO has a stability temperature of up to 710° C. in air and/or up to 2500° C. in vacuum.

21. A method of making an electrode comprising:
preparing a first solution comprising a high surface area host structure and a first solvent;
preparing a second solution comprising a carbon structure and a second solvent;
mixing the first solution with the second solution to form an electrode solution;
sonicating the electrode solution;
heating the electrode solution; and
vacuum drying the electrode solution to form the electrode.

22. The method of claim 21, wherein the first and second solvents comprise at least one of dimethylformamide, acetone, phenol, catechol, and pyrogallol.

23. The method of claim 21, further comprising cooling the electrode solution, filtering the electrode solution, and washing the electrode solution prior to vacuum drying the electrode solution.

24. A method of activating sp² carbon structure comprising:
preparing a solution comprising an sp² carbon structure and an activation reagent;
sonicating the solution;
vacuum filtering the solution to remove the sp² carbon structure from solution;
heating the sp² carbon structure to a temperature of 50-100° C.;
annealing the sp² carbon structure at temperature greater than 700° C. under a nitrogen flow; and
cooling the sp² carbon structure under a nitrogen flow.

25. The method of claim 24, wherein the activation reagent comprises KOH, K₂CO₃, Na₂CO₃, NaOH, ZnCl₂, H₃PO₄.

26. The method of claim 24, wherein the activation reagent has a concentration of about 7M or less in the solution.

27. A method of activating sp² carbon structure comprising:
exposing an sp² carbon structure to nitrogen plasma, NH₃ ultraviolet amination, or ozone.

28. The method of claim 27, wherein exposing the sp² carbon structure to nitrogen plasma, NH₃ ultraviolet amination, or ozone creates perforations in the sp² carbon structure.

29. The method of claim 27, wherein exposing the sp² carbon structure to nitrogen plasma, NH₃ ultraviolet amination, or ozone functionalizes the sp² carbon structure.
